(19) United States
(12) Patent Application Publication
(10) Pub. No.: US 2007/0182822 A1
(43) Pub. Date: Aug. 9, 2007

(54) Media Composer

(75) Inventors: Leland E. Hale, South Colby, WA (US); Ajitesh Kishore, Kirkland, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/275,119

(22) Filed: Dec. 12, 2005

(51) Int. Cl. H04N 5/225; H04B 7/00

(52) U.S. Cl. 348/207.99; 455/511; 455/556.1

(57) ABSTRACT

A mobile device for implementing a media composer is described herein. The mobile device includes an image capturing device and an audio capturing device. Image data is obtained via the image capturing device. Audio data is obtained via the audio capturing device. The image data is associated with the audio data. The image data may then be displayed on the mobile device while the associated audio data is played. The image data and associated audio data forms a data set that may be communicated to a computing device. The computing device may then modify the data set and send the modified data set to the mobile device. The mobile device may then display the modified data set.

### BACKGROUND

It is often convenient to have a mobile device with image and audio capturing capabilities. Some mobile devices, such as cell phones and pocket PCs, are offering users these features. A cell phone may have a digital camera for taking pictures or capturing video, and an audio recorder to record and play back audio tracks. However, users cannot combine the images with the audio recordings, combine images together, or send combined images and recordings to other mobile or computing devices.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Described herein are various technologies and techniques directed to methods and systems for implementing a media composer. In accordance with one implementation of the described technologies, a mobile device, such as a cellular phone, has an audio capturing device for recording and playing back audio tracks and an image capturing device, such as a digital camera, for recording video and taking pictures. A user may take a picture or a video with the image capturing device and then choose to record an audio track to be associated with the picture or video. Alternatively, the user may record an audio track and then choose to take a picture or video to be associated with the audio track.

Once a picture or video has been associated with an audio track, the picture or video may be displayed while the audio track is played. The picture or video and associated audio track may form a data set that may be sent to a computing device. The computing device may modify the data set and then send the modified data set back to the mobile device. The mobile device may then display the modified data set, which may include a modified picture, video, and/or audio track.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram illustrating an exemplary system for a media composer.

FIG. 2 is a flow diagram illustrating an exemplary process for adding audio to a visual.

FIG. 3 is a flow diagram illustrating an exemplary process for adding a visual to recorded audio.

FIG. 4 is a flow diagram illustrating an exemplary process for associating and displaying image data with audio data on a mobile device.

FIG. 5 is a flow diagram illustrating an exemplary process for communicating an associated set of image data and audio data on a mobile device.

FIG. 6 is a screenshot illustrating an exemplary user interface for adding audio to a visual.

FIG. 7 is a screenshot illustrating an exemplary user interface for adding a visual to recorded audio.

FIG. 8 is a screenshot illustrating an exemplary user interface for creating slide shows with stored image data.

FIG. 9 illustrates an exemplary computing environment in which certain aspects of the invention may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

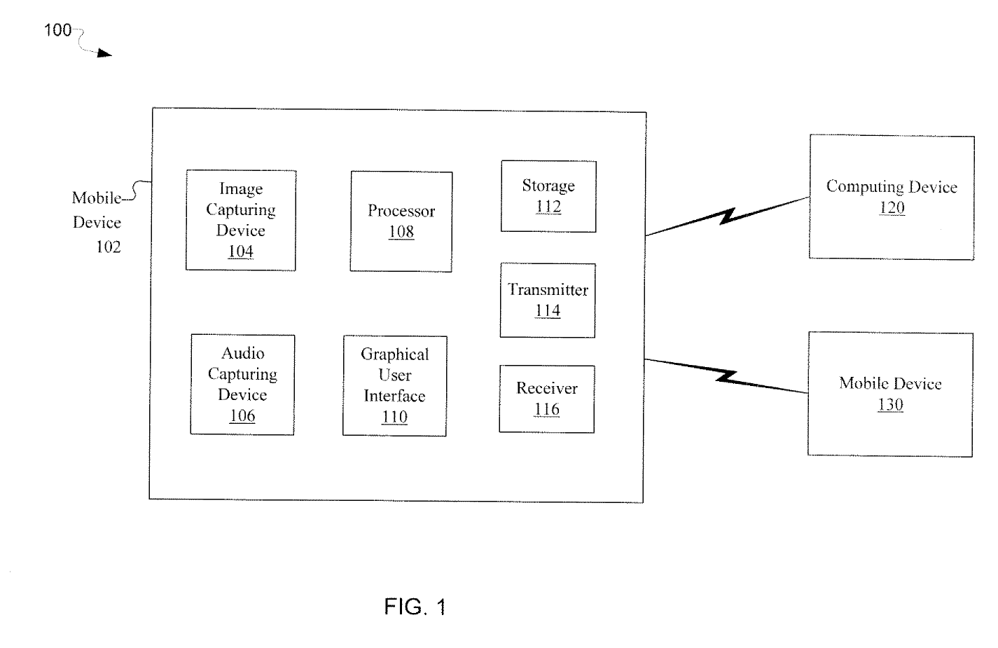

FIG. 1 is a block diagram illustrating an exemplary system 100 for a media composer. System 100 includes a mobile device 102. Mobile device 102 includes an image capturing device 104 and an audio capturing device 106. Mobile device 102 may also include a processor 108, a graphical user interface 110, a storage device 112, a transmitter 114, and a receiver 116. The mobile device 102 may be a cellular phone, a SmartPhone, a pocket PC, or any other type of mobile device with an image capturing device and an audio capturing device.

The audio capturing device 106 enables a user to record and play back audio tracks. The image capturing device 104 may be used to capture one or more images, such as pictures or photos. In addition, the image capturing device 104 may be used to capture one or more videos. In one exemplary implementation, the image capturing device 104 may be a digital camera integrated with the mobile device 102.

The captured images, videos, and audio may be stored in the storage device or memory 1 12. A user may choose to add audio to a stored image or video. The user selects the desired image or video. The graphical user interface 110 displays the selected image or video along with a menu of options. The user may then select the add audio option from the menu. In response, the mobile device 102 switches to the audio capturing mode and the audio capturing device 106 starts recording. When the user is done recording, the recorded audio is stored and associated with the selected image or video.

A user may choose to add an image or video to a stored audio track. The user selects the desired audio track. The graphical user interface 110 displays the name of the audio track along with a menu of options. The user may then select the add visual option from the menu. In response, the mobile device 102 switches to the image capturing mode and the image capturing device 104 captures the image or video. The captured image or video is then stored and associated with the selected audio track.

After an image has been associated with an audio track, a user may select the image, and the image will be displayed while the associated audio track is played. Similarly, if the user selects the audio track, the audio track will be played while the associated image is displayed.

A user may choose to create a slide show with stored images. A list of the stored images are displayed for the user via the graphical user interface 110. The user may then select a plurality of the images and the order in which the images should be organized. The images are then combined serially to create a slideshow or video.

The combined images and audio recordings may be sent to another device, such as computing device 120 or mobile device 130. Computing device 120 or mobile device 130 may view and modify the received images and associated audio recordings. For example, possible modifications may include but are not limited to replacing an audio track, replacing an image, or reorganizing the images in a slide show. When the images and associated audio recordings are modified, the modified set of images and associated audio recordings may be sent back to the mobile device 102. Mobile device 102 may then display the modified set of images and associated audio recordings.

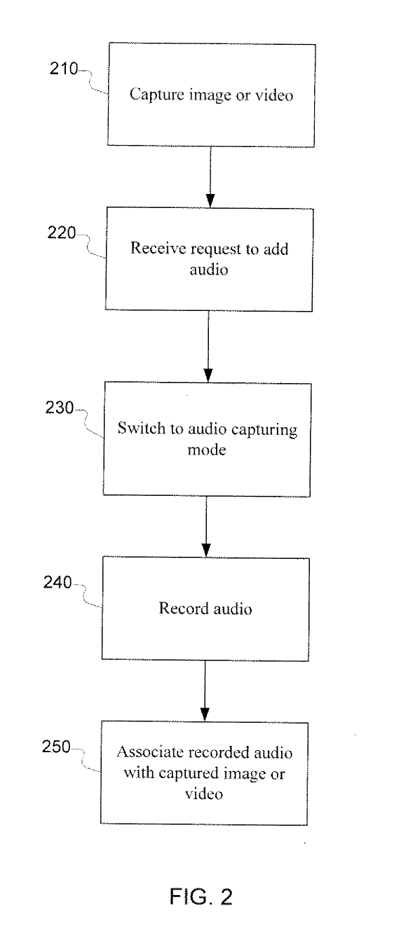

FIGS. 2-5 are flow diagrams illustrating exemplary processes for a media composer. While the description of FIGS. 2-5 may be made with reference to other figures, it should be understood that the exemplary processes illustrated in FIGS. 2-5 are not intended to be limited to being associated with the systems or other contents of any specific figure or figures. Additionally, it should be understood that while the exemplary processes of FIGS. 2-5 indicate a particular order of operation execution, in one or more alternative implementations, the operations may be ordered differently. Furthermore, some of the steps and data illustrated in the exemplary processes of FIGS. 2-5 may not be necessary and may be omitted in some implementations. Finally, while the exemplary processes of FIGS. 2-5 contains multiple discrete steps, it should be recognized that in some environments some of these operations may be combined and executed at the same time.

FIG. 2 is a flow diagram illustrating an exemplary process for adding an audio track to a captured image or video. At 210, an image or video is captured via the image capturing device of the mobile device. The captured image or video may be stored. A user may then choose to add audio to the captured image or video. At 220, the user's request to add audio is received. At 230, the mobile device switches to the audio capturing mode. At 240, the audio capturing device records the audio. At 250, the recorded audio is associated with the captured image or video. The recorded audio and associated image or video may be stored as a data set.

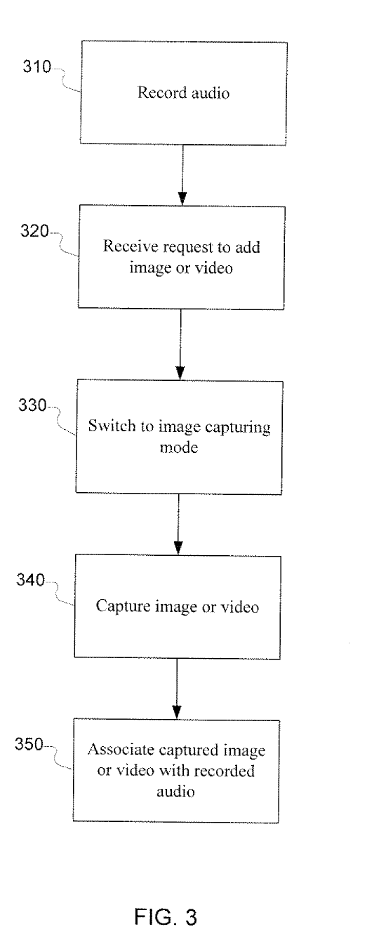

FIG. 3 is a flow diagram illustrating an exemplary process for adding an image or video to a recorded audio track. At 310, an audio track is recorded via the audio capturing device of the mobile device. The recorded audio track may be stored. A user may then choose to add an image or video to the recorded audio track. At 320, the user's request to add the image or video is received. At 330, the mobile device switches to the image capturing mode. At 340, the image capturing device captures the image or video. At 350, the captured image or video is associated with the recorded audio track. The recorded audio track and associated image or video may be stored as a data set.

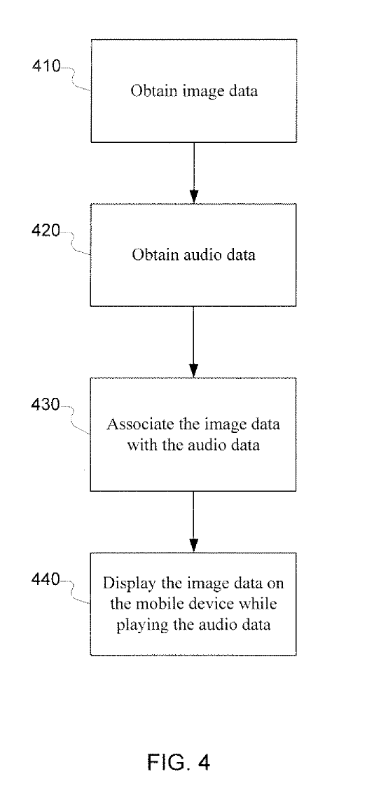

FIG. 4 is a flow diagram illustrating an exemplary process for associating and displaying image data with audio data on a mobile device. A user may choose to capture one or more images or videos using the mobile device. The mobile device switches to image capturing mode. At 410, image data is obtained via the image capturing device.

The user may choose to record audio using the mobile device. The mobile device switches to audio capturing mode. At 420, audio data is obtained via the audio capturing device.

At 430, the captured image data is associated with the captured audio data. The image data may be combined with the audio data to form a data set. When the image data, audio data, or data set is selected, then at 440, the image data may be displayed on the mobile device while the associated audio data is played.

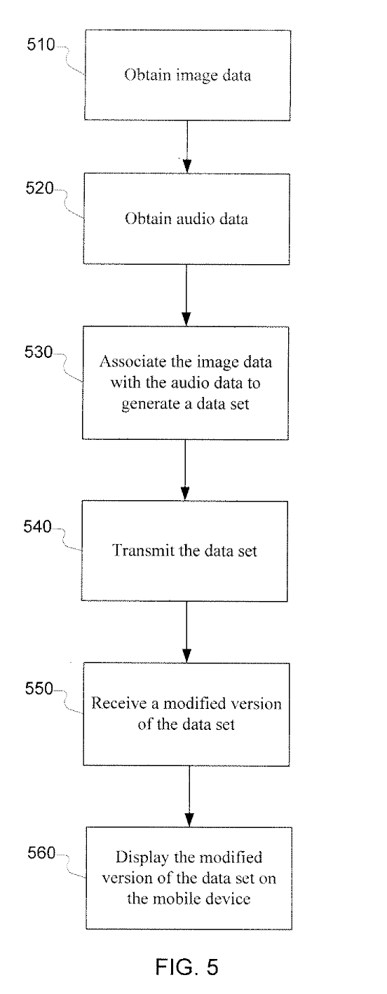

FIG. 5 is a flow diagram illustrating an exemplary process for communicating an associated set of image data and audio data. At 510, image data is obtained via the image capturing device of the mobile device. At 520, audio data is obtained via the audio capturing device of the mobile device. At 530, the image data is associated with the audio data to generate a data set. At 540, the data set may be transmitted to another device, such as a computing device. The data set is modifiable by the computing or other device. At 550, the mobile device receives a modified version of the data set. For example, the data set may have been modified by replacing an audio track with another audio track, replacing an image with another image, or reorganizing images in a slide show. At 560, the modified version of the data set is displayed on the mobile device.

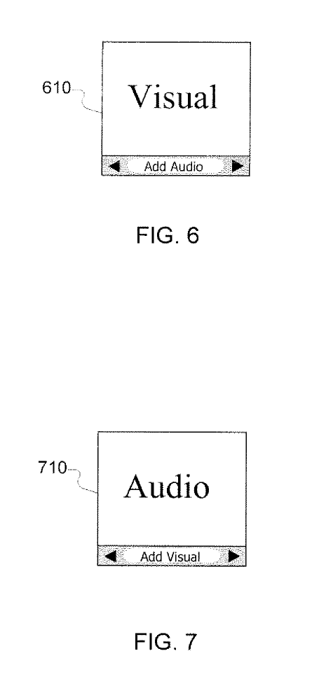

FIG. 6 is a screenshot illustrating an exemplary user interface for adding audio to a visual. When a user selects an image or video, the user may see a user interface such as 610. The image or video is displayed in the “Visual” display portion of the screen. A navigable menu may be displayed on the screen with a plurality of choices for the user. A user may navigate from one choice to another, for example, by using the forward arrow or back arrow.

Examples of choices in the menu include but are not limited to add audio, add visual, save slide, new slide, or create show. When the user selects the add audio option from the menu, the mobile device may go into record mode and use the audio capturing device to record an audio track that will be associated with the selected image or video. When the user selects the add visual option from the menu, the mobile device may switch to the image capturing mode and capture another image or video.

When the user selects the save slide option from the menu, the data set that includes the image data and the associated audio data may be saved. According to one exemplary implementation, each data set may be named with a predetermined extension, such as .ppm. The user may choose a name for the slide, or the slide may be auto-named sequentially, such as “Slidel.ppm” for the first slide, “Slide2.ppm” for the second slide, and so forth.

When the user selects the new slide option from the menu, the user may capture an additional image and associate an audio track with the additional image. When the user selects the create show option from the menu, a list of the current slides is displayed for the user. The user may then select slides from the list and reorder the slides to generate a slide show.

FIG. 7 is a screenshot illustrating an exemplary user interface for adding a visual to an audio track. When the user selects an audio track, the user may see a user interface such as 710. The user may navigate through a plurality of choices via a menu displayed on the screen. Examples of choices in the menu include but are not limited to add visual, save slide, add audio, new slide, or create show. When the user selects the add visual option from the menu, the mobile device may switch to the image capturing mode and capture an image or video and associate the image or video with the selected audio track. When the user selects the save slide option from the menu, the mobile device may save the data set that includes the audio track and the associated image or video. When the user selects the add audio option from the menu, the mobile device may go into audio capturing mode and use the audio capturing device to record an additional audio track. When the user selects the new slide option from the menu, the mobile device may go into record mode to record additional audio and associate an image or video with the additional audio. When the user selects the create show option from the menu, a list of the current slides is displayed for the user. The user may then select slides from the list and reorder the slides to generate a slide show.

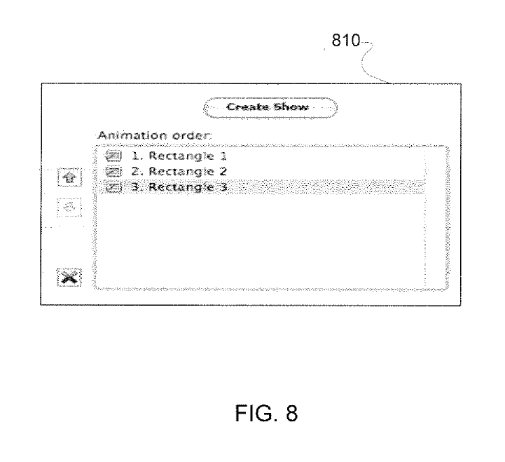

FIG. 8 is a screenshot illustrating an exemplary user interface 800 for creating a slide show with stored image data. When a user selects the create show option from the menu screen of a selected image or audio track, the user may see a user interface such as 810. The mobile device displays a list of the saved slides. The user may modify any slide by double-clicking on the slide. The mobile device may then open a dialog box that lists the associated visual file and audio file. The user may then select to replace either the audio file or the visual file. If the user selects to replace the audio file, the mobile device may record another audio track and associate the audio track with the visual file. If the user selects to replace the visual file, the mobile device may capture another image or video and associate the image or video with the audio file.

From the displayed list of slides, the user may select one or more of the slides for the slide show. The user may also delete any slides from the list and reorder the slides on the list. Then, the user may click on “create show” and the mobile device will combine the slides to generate a slide show.

The slides selected for the slide show may be saved as a data set. When the user chooses to view the slide show, the data set may be displayed for the user. The data set may also be sent to another device, such as a computing device. The computing or other device may modify the data set, such as reorganizing the slides or adding, removing, or replacing one or more slides in the slide show. The modified data set may then be sent back to the mobile device. The mobile device may then display the modified data set for the user. The user will then see the modified slide show.

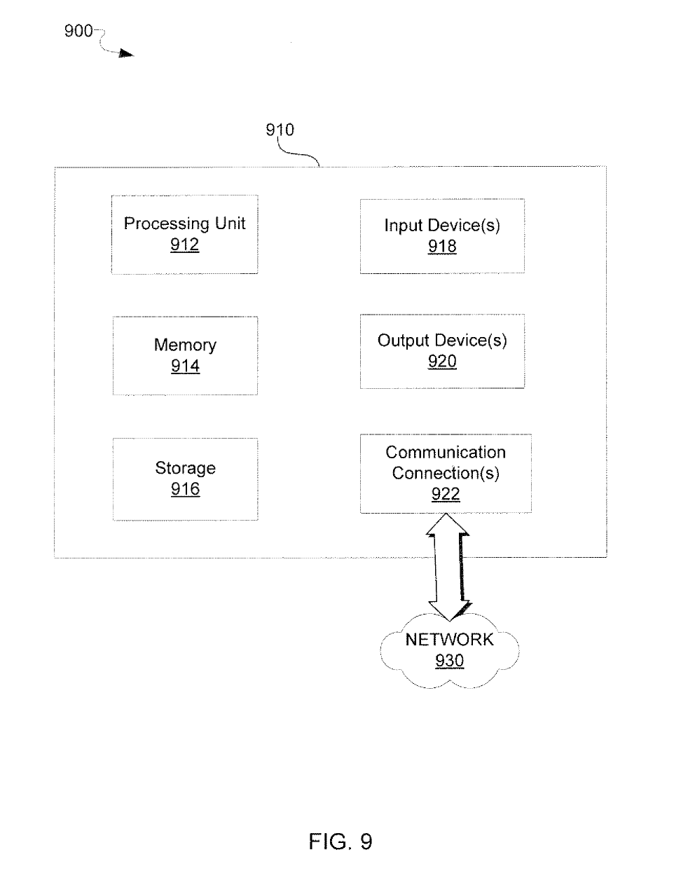

FIG. 9 illustrates an exemplary computing environment in which certain aspects of the invention may be implemented. It should be understood that computing environment 900 is only one example of a suitable computing environment in which the various technologies described herein may be employed and is not intended to suggest any limitation as to the scope of use or functionality of the technologies described herein. Neither should the computing environment 900 be interpreted as necessarily requiring all of the components illustrated therein.

The technologies described herein may be operational with numerous other general purpose or special purpose computing environments or configurations. Examples of well known computing environments and/or configurations that may be suitable for use with the technologies described herein include, but are not limited to, personal computers, server computers, hand-held devices, mobile devices, laptop devices, tablet devices, multiprocessor systems, microprocessor-based systems, set top boxes, programmable consumer electronics, network PCs, minicomputers, mainframe computers, distributed computing environments that include any of the above systems or devices, and the like.

With reference to FIG. 9, computing environment 900 includes a general purpose computing device 910. Components of computing device 910 may include, but are not limited to, a processing unit 912, a memory 914, a storage device 916, input device(s) 918, output device(s) 920, and communications connection(s) 922.

Depending on the configuration and type of computing device, memory 914 may be volatile (such as RAM), non-volatile (such as ROM, flash memory, etc.) or some combination of the two. Computing device 910 may also include additional storage (removable and/or non-removable) including, but not limited to, magnetic or optical disks or tape. Such additional storage is illustrated in FIG. 9 by storage 916. Computer storage media includes volatile and nonvolatile, removable and non-removable media implemented in any method or technology for storage of information such as computer readable instructions, data structures, program modules or other data. Memory 914 and storage 916 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 910. Any such computer storage media may be part of computing device 910.

Computing device 910 may also contain communication connection(s) 922 that allow the computing device 910 to communicate with other devices, such as with other computing devices through network 930. Communications connection(s) 922 is an example of communication media. Communication media typically embodies computer readable instructions, data structures, program modules or other data in a modulated data signal such as a carrier wave or other transport mechanism and includes any information delivery media. The term ‘modulated data signal’ means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes storage media.

Computing device 910 may also have input device(s) 918 such as a keyboard, a mouse, a pen, a voice input device, a touch input device, and/or any other input device. Output device(s) 920 such as one or more displays, speakers, printers, and/or any other output device may also be included.

While the invention has been described in terms of several exemplary implementations, those of ordinary skill in the art will recognize that the invention is not limited to the implementations described, but can be practiced with modification and alteration within the spirit and scope of the appended claims. The description is thus to be regarded as illustrative instead of limiting.

1. On a mobile device, wherein the mobile device comprises an audio capturing device and an image capturing device, a computer-implemented method comprising:
obtaining audio data via the audio capturing device;
obtaining image data via the image capturing device;
associating the audio data with the image data to generate a data set; and
transmitting the data set, wherein the data set is modifiable by a computing device.

2. The method of claim 1, further comprising receiving a modified version of the data set.

3. The method of claim 2, further comprising displaying the modified version of the data set on the mobile device.

4. The method of claim 1, wherein obtaining image data comprises capturing a picture via the image capturing device.

5. The method of claim 1, wherein obtaining image data comprises capturing a video via the image capturing device.

6. The method of claim 1, further comprising obtaining additional image data via the image capturing device.

7. The method of claim 6, further comprising selecting a plurality of the obtained image data to generate a slide show.

8. A mobile device comprising:
an image capturing device to capture image data;
an audio capturing device to capture audio data;
a graphical user interface to enable a user to select one or more of the image data and audio data;
a processing element coupled to the image capturing device, the audio capturing device, and the graphical user interface to process user selections and to associate the selected image data and audio data; and
a transmitter coupled to the processing element to transmit the associated image data and audio data to another mobile device.

9. The mobile device of claim 8, further comprising a receiver to receive a modified version of the associated image data and audio data.

10. The mobile device of claim 8, further comprising a storage device to store the image data and the audio data.

11. The mobile device of claim 8, wherein the image capturing device is a digital camera.

12. One or more device-readable media with device-executable instructions for performing steps comprising:
obtaining image data via an image capturing device of a mobile device;
obtaining audio data via an audio capturing device of the mobile device;
associating the image data with the audio data; and
displaying the image data on the mobile device while playing the audio data.

13. The one or more device-readable media of claim 12, wherein obtaining image data comprises capturing a photo.

14. The one or more device-readable media of claim 12, wherein obtaining image data comprises capturing a video.

15. The one or more device-readable media of claim 12, wherein the steps further comprise receiving a request to add an image to the audio data.

16. The one or more device-readable media of claim 15, wherein obtaining image data comprises obtaining image data in response to the request to add an image to the audio data.

17. The one or more device-readable media of claim 12, wherein the steps further comprise receiving a request to add audio to the image data.

18. The one or more device-readable media of claim 17, wherein obtaining audio data comprises obtaining audio data in response to the request to add audio to the image data.

19. The one or more device-readable media of claim 12, wherein the steps further comprise receiving a request to add an additional image to the image data, obtaining the additional image via the image capturing device, and associating the additional image with the image data to generate a data set.

20. The one or more device-readable media of claim 19, wherein the steps further comprise generating a slide show with the data set.
